(19) United States
(12) Patent Application Publication
(10) Pub. No.: US 2020/0228992 A1
(43) Pub. Date: Jul. 16, 2020

(54) Bandwidth Part (BWP) Operations for New Radio in Unlicensed Spectrum (NR-U)

(71) Applicant: MediaTek Inc., Hsinchu (TW)

(72) Inventors: Cheng-Rung Tsai, Hsinchu (TW); Pei-Kai Liao, Hsinchu (TW)

(21) Appl. No.: 16/739,328

(22) Filed: Jan. 10, 2020

Related U.S. Application Data
(60) Provisional application No. 62/790,537, filed on Jan. 10, 2019.

(51) Int. Cl. H04W 16/14; H04W 72/04; H04W 74/08

(52) U.S. Cl. CPC H04W 16/14; H04W 74/0808; H04W 72/042

(57) ABSTRACT

For downlink (DL) reception in an unlicensed spectrum, a UE receives control signaling indicating an active DL bandwidth part (BWP), and DL control information indicating scheduled radio resources within the active DL BWP. The UE receives an encoded signal containing code blocks (CBs) of a transport block (TB) over the clusters in the active DL BWP that are determined to be clear based on listen-before-talk (LBT), and decodes the CBs in a frequency-first order within a cluster of the active DL BWP followed by a time order and then a cluster order in a slot. For uplink (UL) transmission, a UE encodes the CBs in a frequency-first order within a cluster of the active UL BWP followed by a time order and then a cluster order in a slot, and transmits the encoded signal over a cluster of the active UL BWP that is clear for transmission based on LBT.

### CROSS-REFERENCE TO RELATED APPLICATIONS

This application claims the benefit of U.S. Provisional Application No. 62/790,537 filed on Jan. 10, 2019, the entirety of which is incorporated by reference herein.

### TECHNICAL FIELD

Embodiments of the invention relate to wireless communications in an unlicensed spectrum; more specifically, to the mapping of a transport block to time-and-frequency resources in an unlicensed spectrum.

### BACKGROUND

The Fifth Generation New Radio (5G NR) is a telecommunication standard for mobile broadband communications. 5G NR is promulgated by the 3rd Generation Partnership Project (3GPP) to significantly improve on performance metrics such as latency, reliability, throughput, etc. 5G NR supports operations in unlicensed spectrum (NR-U) to provide bandwidth in addition to the mmWave spectrum to mobile users.

The 3GPP defined a coexistence mechanism for different radio air interfaces to share the unlicensed spectrum. Listen-before-talk (LBT) is a mechanism that allows fair sharing of the unlicensed spectrum between networks with different radio air interfaces, e.g., between 5G NR networks and WiFi networks. In the LBT process, a transmitting station before signal transmission listens to (e.g., senses) a channel to determine if the channel is clear for transmission. An LBT failure indicates that the channel is occupied (e.g., used by another transmitting station). To start transmission, the transmitting station waits until LBT succeeds, which indicates that the channel becomes clear. LBT can be performed for each subband, which typically has a 20 MHz bandwidth.

Due to the shared use of the unlicensed spectrum, the available resources for each transmission may be different. Depending on the LBT outcome, a subband that is mapped to transmit a data block may become temporarily unavailable for transmission. The transmitting station may be unable to modify the subband mapping on the fly according to the LBT outcome. Therefore, data mapped to an unavailable subband is re-transmitted. There is a need to minimize the re-transmission cost for wireless communication in the unlicensed spectrum.

### SUMMARY

In one embodiment, a method is provided for wireless communication in an unlicensed spectrum. The method comprises: receiving control signaling which indicates an active downlink (DL) bandwidth part (BWP) among a set of DL BWP configurations provided by a radio resource control (RRC)-layer signaling. The active DL BWP includes one or more clusters. The method further comprises: receiving DL control information carried in a physical DL control channel. The DL control information indicates scheduled radio resources within the active DL BWP for reception of a transport block (TB). The method further comprises: receiving an encoded signal containing code blocks (CBs) of the TB over the clusters that are determined to be clear based on an LBT process performed in the clusters, and decoding the CBs in a frequency-first order within a cluster of the active DL BWP followed by a time order, and further followed by a cluster order in a slot.

In another embodiment, a method is provided for wireless communication in an unlicensed spectrum. The method comprises: receiving control signaling which indicates an active uplink (UL) BWP among a set of UL BWP configurations provided by RRC-layer signaling. The UL BWP includes one or more clusters. The method further comprises: receiving DL control information carried in a physical DL control channel. The DL control information indicates scheduled radio resources within the active UL BWP for transmission of a TB containing a plurality of CBs. The method further comprises: encoding the CBs in a frequency-first order within a cluster of the active UL BWP followed by a time order and further followed by a cluster order in a slot; and transmitting the encoded CBs over a cluster of the active UL BWP when the cluster is determined to be clear for transmission based on an LBT process performed in the cluster.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a network in which the embodiments of the present invention may be practiced.

FIG. 2 is a diagram illustrating the time-and-frequency resources configured for a base station to transmit data to a UE in the related art.

FIG. 3 is a diagram illustrating the time-and-frequency resources configured for a base station to transmit data to a UE according to a first embodiment.

FIG. 4 is a diagram illustrating the time-and-frequency resources configured for a base station to transmit data to a UE according to a second embodiment.

FIG. 5 is a diagram illustrating the time-and-frequency resources configured for a base station to transmit data to a UE according to a third embodiment.

FIG. 6 is a diagram illustrating the partitioning of a transport block (TB) according to one embodiment.

FIG. 7 is a flow diagram illustrating a method for a UE to receive downlink data transmission in an unlicensed spectrum according to one embodiment.

FIG. 8 is a flow diagram illustrating a method for a UE to transmit uplink data in an unlicensed spectrum according to one embodiment.

FIG. 9 is a flow diagram illustrating a method for an apparatus to receive wireless communication in an unlicensed spectrum according to one embodiment.

FIG. 10 is a flow diagram illustrating a method for an apparatus to transmit wireless communication in an unlicensed spectrum according to one embodiment.

FIG. 11 is a block diagram illustrating elements of an apparatus operable to perform wireless communication in an unlicensed spectrum according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a mechanism for transmitting and receiving a transport block (TB) on available bandwidths in an unlicensed spectrum without changing the TB. A number of mapping schemes are disclosed for mapping code blocks (CBs) of a TB into available bandwidths. The disclosed mapping schemes reduce error rates as well as the cost of re-transmissions from a transmitting station to a receiving station. The disclosed mechanism may be applied to wireless communication between a base station (known as gNodeB or gNB in a 5G network) and a user equipment terminal (UE).

In a 5G NR network, a base station such as a gNB may operate within one or more bandwidth parts (BWPs). In the case of multiple BWPs, the parameters of these BWPs may be different from each other, such as antenna multiple-input-multiple-output (MIMO) parameters. The base station may configure one or more BWPs for a UE through radio resource control (RRC) signaling, and activate only one BWP for the communication between the UE and the base station. The UE may transmit and receive TBs in the activated BWP (frequency resources) and scheduled symbol time (time resources). The frequency resources and the time resources are herein collectively referred to as the time-and-frequency resources.

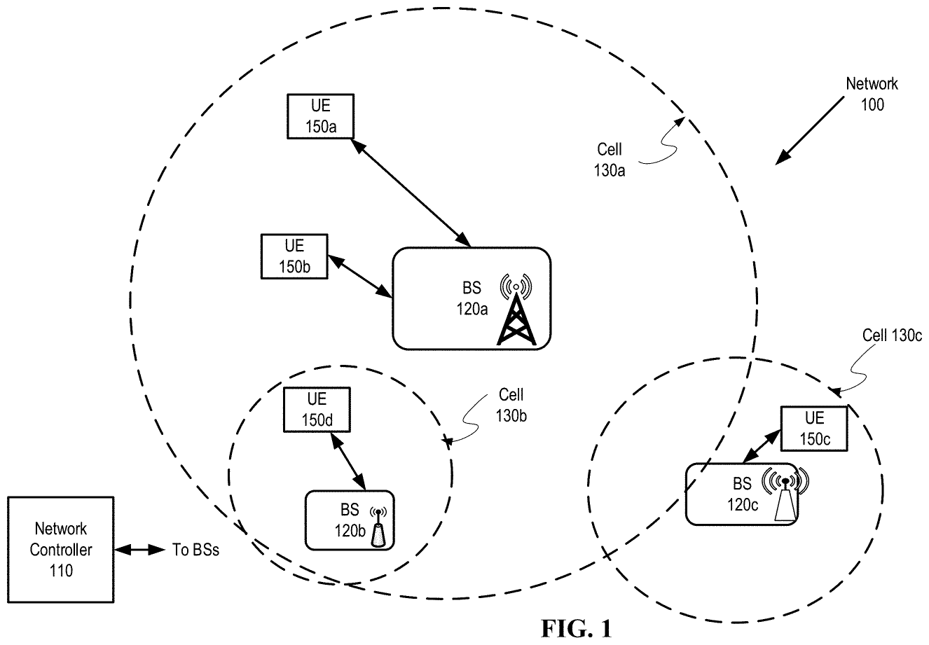

FIG. 1 is a diagram illustrating a network 100 in which the embodiments of the present invention may be practiced. The network 100 is a wireless network which may be a 5G NR network. To simplify the discussion, the methods and apparatuses are described within the context of a 5G NR network. However, one of ordinary skill in the art would understand that the methods and apparatuses described herein may be applicable to a variety of other multi-access technologies and the telecommunication standards that employ these technologies.

The number and arrangement of components shown in FIG. 1 are provided as an example. In practice, the network 100 may include additional devices, fewer devices, different devices, or differently arranged devices than those shown in FIG. 1.

Referring to FIG. 1, the network 100 may include a number of base stations (shown as BSs), such as base stations 120a, 120b, and 120c, collectively referred to as the base stations 120. In some network environments such as a 5G NR network, a base station may be known as a gNodeB, a gNB, and/or the like. In an alternative network environment, a base station may be known by other names. Each base station 120 provides communication coverage for a particular geographic area known as a cell, such as a cell 130a, 130b or 130c, collectively referred to as cells 130. The radius of a cell size may range from several kilometers to a few meters. A base station may communicate with one or more other base stations or network entities directly or indirectly via a wireless or wireline backhaul.

A network controller 110 may be coupled to a set of base stations such as the base stations 120 to coordinate, configure, and control these base stations 120. The network controller 110 may communicate with the base stations 120 via a backhaul.

The network 100 further includes a number of UEs, such as UEs 150a, 150b, 150c and 150d, collectively referred to as the UEs 150. The UEs 150 may be anywhere in the network 100, and each UE 150 may be stationary or mobile. The UEs 150 may also be known by other names, such as a mobile station, a subscriber unit, and/or the like. Some of the UEs 150 may be implemented as part of a vehicle. Examples of the UEs 150 may include a cellular phone (e.g., a smartphone), a wireless communication device, a handheld device, a laptop computer, a cordless phone, a tablet, a gaming device, a wearable device, an entertainment device, a sensor, an infotainment device, Internet-of-Things (IoT) devices, or any device that can communicate via a wireless medium.

In one embodiment, the UEs 150 may communicate with their respective base stations 120 in their respective cells 130. The transmission from a UE to a base station is called uplink transmission, and from a base station to a UE is called downlink transmission.

It is noted that while the disclosed embodiments may be described herein using terminology commonly associated with 5G or NR wireless technologies, the present disclosure can be applied to other multi-access technologies and the telecommunication standards that employ these technologies.

In one embodiment, data is transmitted between a base station and a UE as one or more TBs. Each TB may be partitioned into a plurality of CBs. Each CB is attached with an error correction code, such as the cyclic redundancy code (CRC). For 5G NR, a channel coding process is performed on each code block before transmission, followed by scrambling, modulation, and resource element mapping. The amount of time-and-frequency resources used by each CB is determined by the code complexity, required code rate, error correction properties, etc.

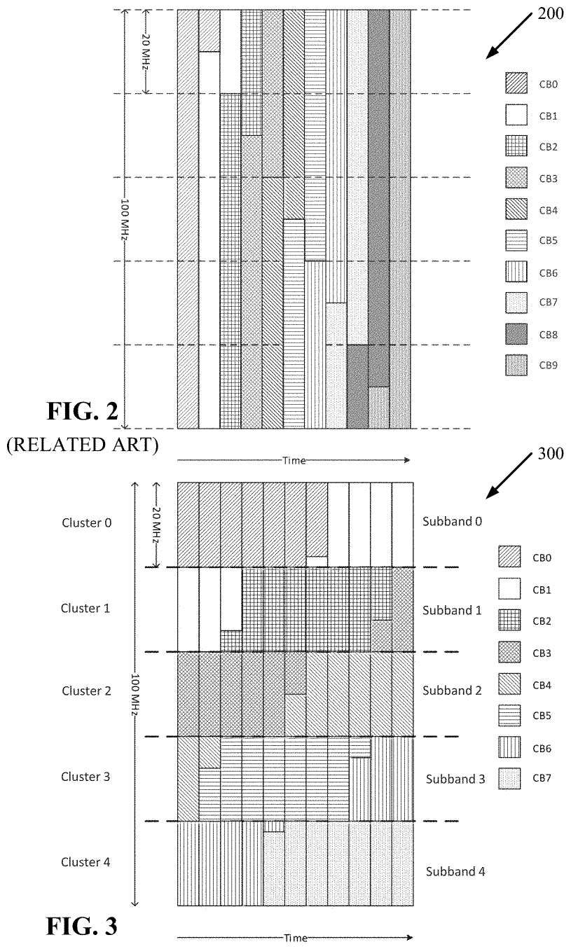

FIG. 2 is a diagram 200 illustrating the time-and-frequency resources configured for a base station to transmit data to a UE in the related art. The time-and-frequency resources may be a part of a physical downlink shared channel (PDSCH) for carrying UE-specific data. In this example, the data to be transmitted forms ten code blocks (CB0-CB9). The ten CBs are placed in the time-and-frequency resources that span over eleven symbols along the time axis and 100 MHz along the frequency axis. The 100 MHz illustrated here is an example of a BWP. The ten CBs are mapped into the resources according to an increasing order of the CB index, and the resources are filled up frequency-first; that is, the CBs fills up the bandwidth of the first symbol first (in the direction from low frequency to high frequency), then the second symbol, the third symbol, and so on.

A BWP may include multiple subbands. In one embodiment, a subband has a bandwidth of 20 MHz. In NR-U, a base station performs listen-before-talk (LBT) on each subband in which it intends to transmit a signal. The base station transmits a signal in a subband when that subband passes LBT (i.e., when LBT succeeds in that subband), which is an indication that the subband is clear for transmission. If the base station transmits in a subband that fails LBT (i.e., when LBT fails in that subband), signals transmitted in that subband can be corrupted and need re-transmission. Depending on the LBT outcome, the available frequency resources for each transmission may be different. It is not generally feasible for a base station to re-map the CBs to a different subband on the fly after LBT because of the complexity and processing time. Thus, even though the base station finds out that LBT fails in a given subband, the base station may still transmit the mapped CBs in the given subband. The base station may transmit the CBs in the given subband, or disable the transmission of the CBs (e.g, by puncturing out and not transmitting those CBs) in the given subband, and re-transmit those CBs in the next transmission opportunity.

Thus, according to the example of FIG. 2, if the first subband (e.g., the topmost 20 MHz bandwidth as shown) does not pass LBT, each of the ten CBs will have a portion of it corrupted, and, therefore, the base station needs to re-transmit all ten CBs. This mapping scheme causes a high error rate and a high re-transmission cost.

In the embodiments to be described below with reference to FIGS. 3-5, a BPW can be partitioned into multiple clusters. Each cluster has the bandwidth of one or more subbands. If LBT fails in one subband in downlink transmission, the UE may receive noise in that subband. A UE's digital front end may include a filter that matches the cluster bandwidth. In one embodiment, the UE may turn off or disable the filter to block reception from that subband for the remaining transmission time of the TB.

Although downlink transmission is described with reference to FIGS. 2-5, it is understood that the various mapping schemes described herein are also applicable to uplink transmission. That is, the time-and-frequency resources shown in FIG. 2-5 may be a part of PDSCH or a part of a physical uplink shared channel (PUSCH).

FIG. 3 is a diagram 300 illustrating the time-and-frequency resources configured for a base station to transmit data to a UE according to a first embodiment. The time-and-frequency resources includes a BWP containing five subbands in frequency, and eleven symbols in time. More specifically, the mapping scheme in diagram 300 maps eight CBs into a BWP containing five subbands. In this embodiment, each subband forms a cluster; that is, each cluster contains a single subband. Each CB is placed into one or more clusters, and each cluster can have one or more CBs. For example, CB0 is mapped into cluster 0, CB1 is mapped into cluster 0 and cluster 1, CB2 is mapped into cluster 1, etc. That is, one CB can be mapped across multiple clusters. For a given CB, when there is no available resource in the current cluster and the CB is not fully mapped, the remaining part of the CB is mapped into other clusters.

Thus, according to the example of FIG. 3, if LBT fails only in subband 0, two (CB0 and CB1) out of the eight CBs may be corrupted. Since the UE can individually acknowledge the data reception in each cluster, the base station will re-transmit these two CBs. If LBT fails only in subband 1, three CBs (CB1, CB2 and CB3) may be corrupted and need re-transmission. That is, all CBs in the same cluster (which contains the subband that fails LBT) are re-transmission. This is an improvement over the example in FIG. 2 where the base station needs to re-transmit all of the CBs in a TB when LBT fails in any one of the subbands.

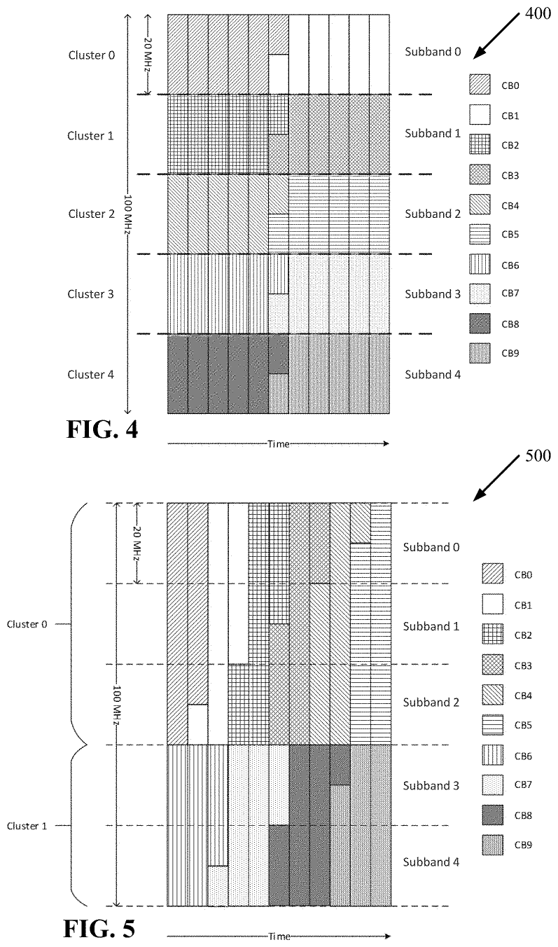

FIG. 4 is a diagram 400 illustrating the time-and-frequency resources configured for a base station to transmit data to a UE according to a second embodiment. More specifically, the mapping scheme shown in diagram 400 maps ten CBs into a BWP containing five subbands. In this embodiment, each subband forms a cluster; that is, each cluster contains a single subband. Each CB is mapped into one cluster, and each cluster can have one or more CBs. In the example of FIG. 4, each cluster contains two CBs; e.g., CB0 and CB1 are mapped into cluster 0, CB2 and CB3 are mapped into cluster 1, CB4 and CB5 are mapped into cluster 2, etc. A difference in diagram 400 from diagram 300 is that each CB is confined within a single cluster in diagram 400. If a CB cannot be fully mapped into one cluster, that CB may be truncated to fit into the cluster.

Thus, according to the example of FIG. 4, if LBT fails in any one of the subbands, two CBs may be corrupted. Since the UE can individually acknowledge the data reception in each cluster, the base station will re-transmit only two CBs when LBT fails in any one of the subbands. This is an improvement over the example in FIG. 3 where the base station may need to re-transmit more than two CBs in some of the subbands.

FIG. 5 is a diagram 500 illustrating the time-and-frequency resources configured for a base station to transmit data to a UE according to a third embodiment. Similar to the examples in FIG. 3 and FIG. 4, the mapping scheme shown in diagram 500 maps ten CBs into a BWP containing five subbands. In this embodiment, each cluster contains two or more subbands. Each CB is mapped into one cluster, and each cluster can have one or more CBs. In the example of FIG. 5, cluster 0 contains six CBs and cluster 1 contains four CBs. Each CB is confined within a single cluster. If a CB cannot be fully mapped into one cluster, that CB may be truncated to fit into the cluster.

Thus, according to the example of FIG. 5, if LBT fails in any one subband in a cluster, the base station may transmit no CB at all in that cluster. For example, if LBT fails in subband 1 and succeeds in subband 0 and subband 2, the base station may disable the transmission of CB0-CB5 (i.e., all of those CBs mapped to cluster 0). Even though LBT succeeds in the two neighboring subbands of subband 1, the noise or signals in subband 1 may interfere with the data transmission in the other subbands of the same cluster. Thus, CBs in a cluster can be transmitted if LBT succeeds for all the subbands within the cluster.

Since the UE can individually acknowledge the data reception in each cluster, the base station will re-transmit all the CBs in cluster 0 when LBT fails only in subband 1. When the UE fails to decode any signal in subband 1, the UE may use its front end filter to block out (i.e., disable the reception of) all signals in cluster 0 until the TB transmission is over or until signals in cluster 0 become decodable. The base station will re-transmit CB0-CB5 in the next transmission opportunity. This is an improvement over the example in FIG. 2 where the base station may need to re-transmit all of CBs in a TB. Although in FIG. 5 the number of CBs to re-transmit is higher than the examples in FIG. 3 and FIG. 4, not every UE can support a filter per subband for the single-subband per cluster embodiments. Combining multiple subbands into one cluster can reduce hardware complexity, footprint and cost of the UE.

In the examples of FIG. 4 and FIG. 5, each cluster has a set of one or more CBs mapped to it and the CBs are wholly confined within that cluster. The set of CBs mapped to the same cluster is also referred to as a CB group (CBG). That is, there is a one-to-one mapping between a cluster and a CBG. A hybrid automatic repeat request (HARQ) is performed per cluster. That is, a receiving station (e.g., a UE) acknowledges the reception of CBs for each cluster. If any CB in a CBG is not received correctly (e.g., the CRC checks fails for the CB or LBT fails in the corresponding cluster), the CBs in the entire cluster are re-transmitted.

The disclosed mapping schemes limit the number of CBs affected by failed LBT. The clusters in a BWP may have the same bandwidth or different bandwidths. Each cluster contains a continuous range of frequencies. In one embodiment, the clusters in a BWP may form a continuous range of frequencies; that is, each cluster is adjacent to at least another cluster in frequency. Alternatively, the clusters in a BWP may be discontinuous in frequency, that is, a BWP may include one or more frequency gaps that are not occupied by any clusters.

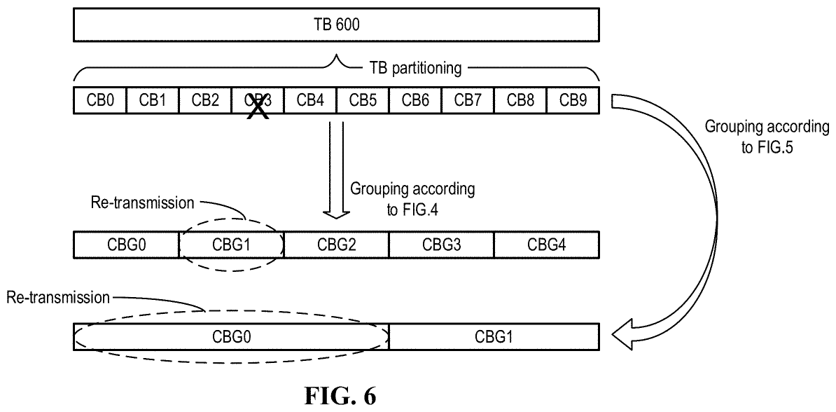

FIG. 6 is a diagram illustrating the partitioning of a TB 600 according to one embodiment. In this example, the TB 600 is partitioned into ten CBs (e.g., CB0-CB9). According to the example of FIG. 4, the CBs are grouped into five CBGs, with each CBG containing two CBs having consecutive CB indices. For example, if CB3 fails the CRC check, the entire CBG1 (which contains CB2 and CB3) is re-transmitted according to the mapping in FIG. 4. According to the example of FIG. 5, the CBs are grouped into two CBGs, with CBG0 containing the first six CBs and CBG1 containing the last four CBs. For example, if CB3 fails the CRC check, the entire CBG0 (which contains CB0-CB5) is re-transmitted according to the mapping in FIG. 5.

As another example, if LBT fails in subband 1 to which CB2 and CB3 are mapped according to FIG. 4, the entire CBG1 containing CB2 and CB3 is re-transmitted. If, in another example, LBT fails in subband 1 to which CB0-CB5 are mapped according to FIG. 5, the entire CBG0 containing CB0-CB5 is re-transmitted. As illustrated in these examples, partitioning a TB into more CBGs improves re-transmission efficiency. However, having more CBGs increases the HARQ overhead, as the receiving station needs to send an ACK or a NACK to acknowledge the reception of each CBG. As mentioned above, the number of clusters in a BWP (i.e., the number of CBG in a TB) may depend on the amount of hardware resources that can be supported by a transmitting/receiving station.

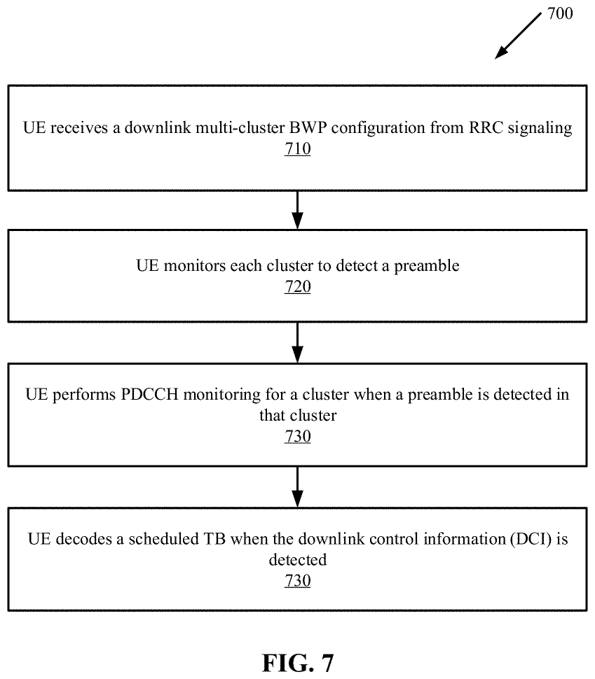

FIG. 7 is a flow diagram illustrating a method 700 for a UE to receive downlink data transmission in an unlicensed spectrum according to one embodiment. The method 700 starts at step 710 when the UE receives a downlink multi-cluster BWP configuration from RRC (Radio Resource Control) signaling. The UE at step 720 monitors each cluster to detect a preamble. The UE at step 730 performs physical downlink control channel (PDCCH) monitoring for a cluster when a preamble is detected in that cluster. The preamble can be cell-specific, BWP-specific or UE-group specific. The UE is not expected to perform PDCCH monitoring if the preamble is not detected by the UE. The UE at step 740 decodes a scheduled TB when the downlink control information (DCI) is detected. According to the method 700, a base station may transmit a TB to a UE without changing the contents of the TB.

In one embodiment, a UE may receive downlink (DL) transmission of a TB in an unlicensed spectrum according to the following method. The UE first determines an active DL BWP from a set of DL BWP configurations provided by RRC-layer signaling. The determination may be made based on a received RRC-layer signaling or a received physical-layer control signaling. The DL BWP contains one or more clusters, and each cluster includes one or more subbands. The UE determines the existence of a serving signal by detecting a physical-layer control channel or its corresponding demodulation reference signal of the serving signal in each cluster of the active DL BWP. The serving signal transmission from the network is based on an LBT process performed in each cluster. In one embodiment, the LBT process may be performed in each subband of the clusters. The UE further identifies the scheduled radio resources within the active DL BWP for the reception of a TB according to DL control information carried in a physical DL control channel. A TB contains multiple CBs. The UE decodes the CBs in a frequency-first order within a cluster of the active DL BWP followed by a time order, and then by a cluster order in a slot. For example, in FIG. 5, the decoding is performed on cluster 0 in a frequency-first order (e.g., from the lowest frequency to the highest frequency in cluster 0) followed by a time order (e.g., from symbol 0 to symbol 10), and repeat the same for cluster 1. In one embodiment, an integer number of CBs are transmitted within a cluster of the active DL BWP in a slot. In one embodiment, each slot contains multiple equal-length symbol durations (also referred to as symbols); e.g., 7 or 14 symbols.

In one embodiment, the UE may locate the PDCCH based on the information in a control resource set (CORESET) and the search space. A CORESET is a set of time-and-frequency resources and associated parameters used for carrying the PDCCH and the DCI, where information about coding and modulation schemes and scheduling can be found. A CORESET may be shared by multiple UEs. In one embodiment, a CORESET may be configured at least for one of the clusters. At most, a CORESET is configured per cluster. In one embodiment, a base station may determine where to place a CORESET based on LBT; e.g., if LBT succeeds in every subband of a cluster, the base station may place a CORESET in that cluster to ensure that the UE can receive that CORESET.

The search space is the time-and-frequency resources where the PDCCH may be carried. A UE performs blind decoding throughout the search space to find the DCI. The search space is UE-specific. The search space may be configured per BWP.

The mapping schemes for CBs have been described above in the context of downlink transmission. In some embodiments, the same mapping schemes may be used for uplink transmission from a UE to a base station in an unlicensed spectrum. In one embodiment, a UE may perform LBT before transmitting uplink signals in a subband. Alternatively, a base station may leave a portion of the time-and-frequency resources unused in a clear subband (i.e., the subband that passes LBT), and the receiving UE may use that unused portion for uplink transmission.

With respect to uplink transmission, a UE transmits uplink signals in a cluster when LBT succeeds for all of the subbands within the cluster. A preamble preceding the physical uplink shared channel (PUSCH), which carries uplink data, is transmitted in a cluster in which the LBT succeeds. The preamble may be cell-specific, BWP-specific or UE-group specific. The same mapping schemes described with reference to FIGS. 3-5 may be used for uplink data transmission. Thus, the disclosure below regarding the CB mapping is applicable to both downlink and uplink transmissions.

The CBs of a TB are mapped per cluster. In one embodiment, the CBs are mapped into a cluster according to an increasing order of the CB indices. That is, a CB with a smaller index is mapped first. A CB is mapped into the available clusters according to an order of the clusters from the lowest-frequency cluster to the highest-frequency cluster. An available cluster is a cluster in which the number of free resources is greater than a predetermined threshold.

A CB is mapped into a cluster in the frequency-first order. According to the frequency-first order, CBs are mapped from one end of the frequency range of the cluster to the other end (e.g., from low to high frequencies) in a first symbol, then repeat the same for each subsequent symbol in the scheduled time to map the rest of the CBs in the same cluster.

As shown in the embodiment of FIG. 3, one CB can be mapped across multiple clusters. For a given CB, when there is no available resource in the current cluster and the CB is not fully mapped, the remaining part of the CB is mapped into other clusters.

As shown in the embodiment of FIG. 4, each CB is mapped into one cluster. For a given CB, when there is no available resource in the current cluster and the CB is not fully mapped, the CB is truncated. In this embodiment, a CB cannot be mapped across multiple clusters.

As shown in the embodiment of FIG. 5, one CB group (CBG) is mapped into one cluster. For a given CBG, when there is no available resource in the current cluster and the CBG is not fully mapped, the CBG is truncated. In this embodiment, a CB cannot be mapped across multiple clusters.

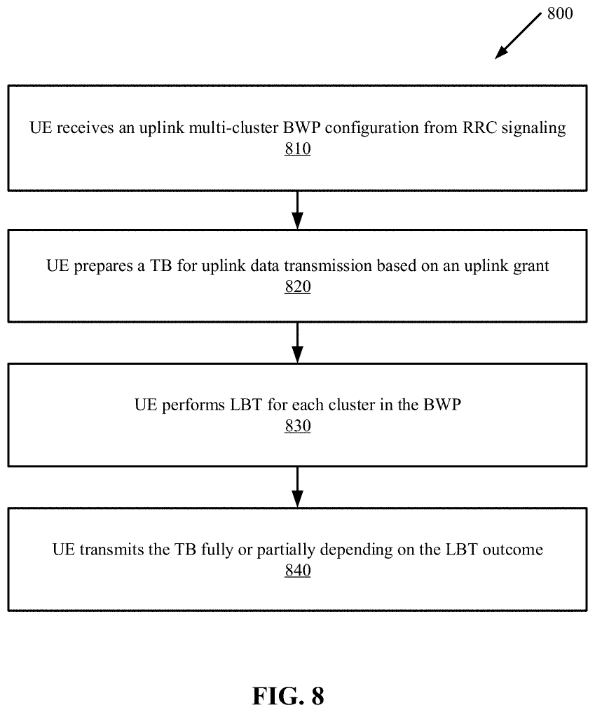

FIG. 8 is a flow diagram illustrating a method 800 for a UE to transmit uplink data in an unlicensed spectrum according to one embodiment. The method 800 starts at step 810 when the UE receives an uplink multi-cluster BWP configuration from RRC signaling. The UE at step 820 receives an uplink grant and prepares a TB of the physical uplink shared channel (PUSCH) based on the uplink grant. The UE at step 830 performs LBT for each cluster in the BWP. The UE at step 840 transmits the TB fully or partially depending on the LBT outcome. According to the method 800, a UE may transmit a TB to a base station without changing the contents of the TB.

In one embodiment, a UE may perform uplink (UL) transmission of a TB in an unlicensed spectrum according to the following method. The UE determines an active UL BWP from a set of UL BWP configurations provided by RRC-layer signaling. The determination may be made based on a received RRC-layer signaling or a received physical-layer control signaling. The UL BWP contains one or more clusters, and each cluster includes one or more subbands. The UE identifies the scheduled radio resources within the active UL BWP for transmission of a TB according to DL control information carried in a physical DL control channel. A TB contains multiple CBs. The UE encodes the CBs in a frequency-first order within a cluster of the active UL BWP followed by a time order, and then by a cluster order in a slot. The UE then transmits the encoded signal over the clusters of the active UL BWP, of which the wireless channel is clear for transmission based on an LBT process performed in each cluster. In one embodiment, the LBT process may be performed in each subband of the clusters. In one embodiment, an integer number of CBs are transmitted within a cluster of the active UL BWP in a slot.

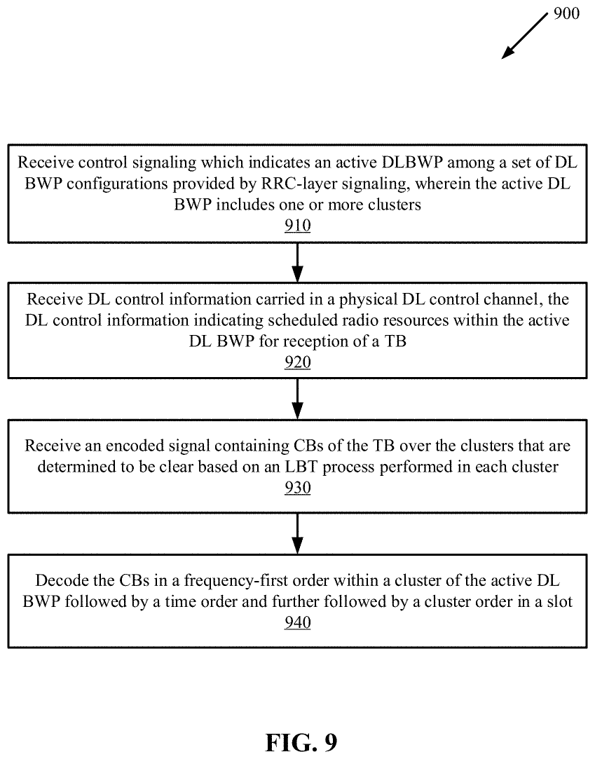

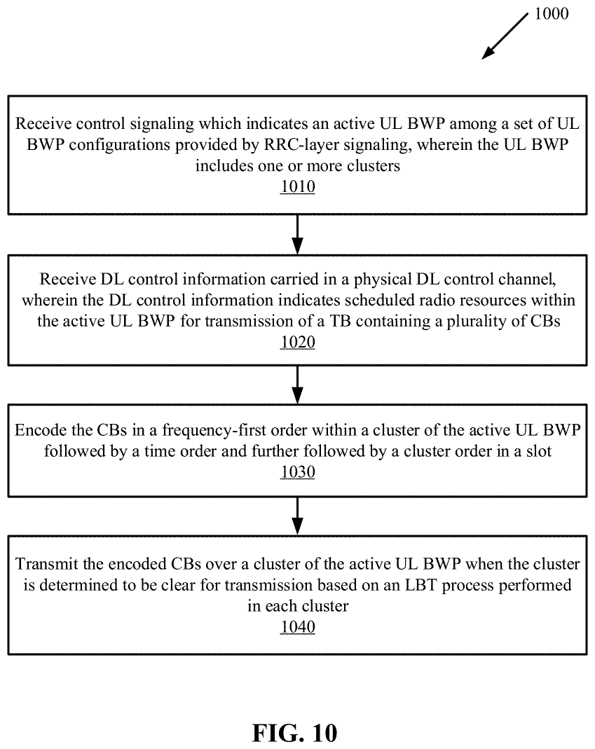

Methods for receiving and transmitting a TB according to embodiments of the invention are further provided below with reference to FIG. 9 and FIG. 10, respectively.

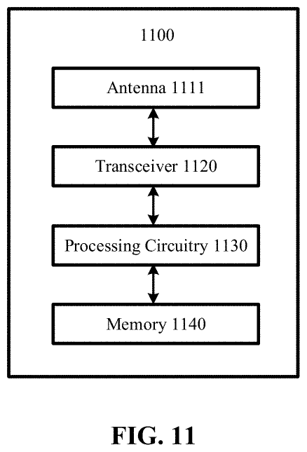

FIG. 9 illustrates a method 900 for an apparatus to receive wireless communication in an unlicensed spectrum according to one embodiment. In one embodiment, the apparatus may be a UE (e.g., any of the UEs 150 in FIG. 1). An example of the apparatus is provided in FIG. 11.

The method 900 begins at step 910 when the apparatus receives control signaling which indicates an active DL BWP among a set of DL BWP configurations provided by RRC-layer signaling. The active DL BWP includes one or more clusters, and each cluster includes one or more subbands. The apparatus at step 920 receives DL control information carried in a physical DL control channel. The DL control information indicates scheduled radio resources within the active DL BWP for the reception of a TB. The apparatus at step 930 receives an encoded signal containing CBs of the TB over the clusters that are determined to be clear based on an LBT process performed in the clusters. The apparatus at step 940 decodes the CBs in a frequency-first order within a cluster of the active DL BWP followed by a time order, and further followed by a cluster order in a slot. Some examples of the clusters according to embodiments of the invention are provided above in FIGS. 3-5.

FIG. 10 illustrates a method 1000 for an apparatus to transmit wireless communication in an unlicensed spectrum according to one embodiment. In one embodiment, the apparatus may be a UE (e.g., any of the UEs 150 in FIG. 1). An example of the apparatus is provided in FIG. 11.

The method 1000 begins at step 1010 when the apparatus receiving control signaling which indicates an active UL BWP among a set of UL BWP configurations provided by RRC-layer signaling. The UL BWP includes one or more clusters, and each cluster includes one or more subbands. The apparatus at step 1020 receives DL control information carried in a physical DL control channel. The DL control information indicates scheduled radio resources within the active UL BWP for transmission of a TB containing a plurality of CBs. The apparatus at step 1030 encodes the CBs in a frequency-first order within a cluster of the active UL BWP followed by a time order and further followed by a cluster order in a slot. The apparatus at step 1040 transmits the encoded CBs over a cluster of the active UL BWP when the cluster is determined to be clear for transmission based on an LBT process performed in the cluster. Some examples of the clusters according to embodiments of the invention are provided above in FIGS. 3-5.

FIG. 11 is a block diagram illustrating elements of an apparatus 1100 (also referred to as a wireless device or station, a wireless communication device or station, etc.) configured to provide wireless communication in an unlicensed spectrum according to one embodiment. In one embodiment, the apparatus 1100 may be a UE. In an alternative embodiment, the apparatus 1100 may be a base station; e.g., a gNB. As shown, the apparatus 1100 may include an antenna 1110, and a transceiver circuit (also referred to as a transceiver 1120) including a transmitter and a receiver configured to provide radio communications with another station in a radio access network, including communication in an unlicensed spectrum. The transmitter and the receiver may include filters in the digital front end for each cluster, and each filter can be enabled to pass signals and disabled to block signals. The apparatus 1100 may also include processing circuitry 1130 which may include one or more signal processors such as encoders, decoders, etc., and may further include one or more processors, cores, or processor cores. The apparatus 1100 may also include a memory circuit (also referred to as memory 1140) coupled to the processing circuitry 1130. The memory 1140 may include computer-readable program code that when executed by the processors causes the processors to perform operations according to embodiments disclosed herein, such as the methods disclosed in FIGS. 7-10, according to the mapping schemes disclosed with reference to any of diagrams 300, 400 and 500 in FIGS. 3-5. The apparatus 1100 may also include an interface (such as a user interface). The apparatus 1100 may be incorporated into a wireless system, a station, a terminal, a device, an appliance, a machine operable to perform wireless communication in an unlicensed spectrum. In one embodiment, the apparatus 1100 operates in a 5G NR-U network. It is understood the embodiment of FIG. 11 is simplified for illustration purposes. Additional hardware components may be included.

Although the UE 1100 is used in this disclosure as an example, it is understood that the methodology described herein is applicable to any computing and/or communication device capable of performing wireless communication in an unlicensed spectrum.

The operations of the flow diagrams of FIGS. 7-10 have been described with reference to the exemplary embodiments of FIGS. 1 and 11. However, it should be understood that the operations of the flow diagrams of FIGS. 7-10 can be performed by embodiments of the invention other than the embodiments of FIGS. 1 and 11, and the embodiments of FIGS. 1 and 11 can perform operations different than those discussed with reference to the flow diagrams. While the flow diagrams of FIGS. 7-10 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for wireless communication in an unlicensed spectrum, comprising:
receiving control signaling which indicates an active downlink (DL) bandwidth part (BWP) among a set of DL BWP configurations provided by Radio Resource Control (RRC)-layer signaling, wherein the active DL BWP includes one or more clusters;
receiving DL control information carried in a physical DL control channel, the DL control information indicating scheduled radio resources within the active DL BWP for reception of a transport block (TB);
receiving an encoded signal containing code blocks (CBs) of the TB over the clusters that are determined to be clear based on a listen-before-talk (LBT) process performed in each cluster; and
decoding the CBs in a frequency-first order within a cluster of the active DL BWP followed by a time order and further followed by a cluster order in a slot.

2. The method of claim 1, wherein an integer number of the CBs are transmitted within a cluster of the active DL BWP in the slot.

3. The method of claim 1, wherein decoding the CBs in each cluster further comprises:
decoding at least one of the CBs from more than one, and less than all, of the plurality of clusters.

4. The method of claim 1, wherein decoding the CBs in each cluster further comprises:
decoding each CB within a single cluster of the plurality of clusters.

5. The method of claim 1, wherein the CBs in the same cluster belong to a same CB group (CBG) and are decoded within the same cluster.

6. The method of claim 1, further comprising:
monitoring, by a user equipment terminal (UE), each cluster to detect a preamble;
performing physical downlink control channel (PDCCH) monitoring for a given cluster when the preamble is detected in the given cluster; and
decoding a scheduled TB when downlink control information (DCI) is detected.

7. The method of claim 6, wherein the preamble is one of: cell-specific, BWP-specific and UE-group specific.

8. The method of claim 6, wherein a control resource set (CORESET), which includes time-and-frequency resources for carrying the PDCCH and the DCI, is configured per cluster.

9. The method of claim 6, wherein a search space specific for the UE for locating the DCI is configured per BWP.

10. The method of claim 1, wherein each cluster includes one or more subbands, the method further comprising:
disabling the data reception for a given cluster when the LBT process fails in a subband of the given cluster.

11. The method of claim 1, further comprising:
receiving the CBs from a physical downlink shared channel (PDSCH) in a 5G NR network.

12. A method for wireless communication in an unlicensed spectrum, comprising:
receiving control signaling which indicates an active uplink (UL) bandwidth part (BWP) among a set of UL BWP configurations provided by Radio Resource Control (RRC)-layer signaling, wherein the UL BWP includes one or more clusters;
receiving DL control information carried in a physical DL control channel, wherein the DL control information indicates scheduled radio resources within the active UL BWP for transmission of a transport block (TB) containing a plurality of code blocks (CBs);
encoding the CBs in a frequency-first order within a cluster of the active UL BWP followed by a time order and further followed by a cluster order in a slot;
transmitting the encoded CBs over a cluster of the active UL BWP when the cluster is determined to be clear for transmission based on a listen-before-talk (LBT) process performed in each cluster.

13. The method of claim 12, wherein an integer number of the CBs are transmitted within a cluster of the active UL BWP in the slot.

14. The method of claim 12, wherein mapping the CBs to the clusters further comprises:
mapping at least one of the CBs to more than one, and less than all, of the plurality of clusters.

15. The method of claim 12, wherein mapping the CBs to the clusters further comprises:
mapping each CB to a single cluster of the plurality of clusters.

16. The method of claim 15, further comprising:
truncating a given CB which is to be mapped to the single cluster when the single cluster has no available resources to fully map the given CB.

17. The method of claim 15, wherein mapping the CBs to the clusters further comprises:
mapping a CB group (CBG) into the single cluster; and
truncating a given CBG which is to be mapped to the single cluster when the single cluster has no available resources to fully map the given CBG.

18. The method of claim 12, wherein the CBs are mapped to the clusters according to a CB index order from a lowest indexed CB to a highest indexed CB.

19. The method of claim 12, further comprising:
preparing, by a user equipment terminal (UE), the TB for uplink data transmission based on the uplink grant;
performing the LBT process for each cluster in the BWP; and
transmitting the TB fully or partially depending on an outcome of the LBT process.

20. The method of claim 12, wherein each cluster includes one or more subbands, the method further comprising:
disabling transmission of the CBs in a given cluster when the LBT process fails in a subband of the given cluster.

21. The method of claim 12, further comprising:
transmitting a preamble preceding the transmission of the TB in each cluster in which the LBT process succeeds, the preamble is one of: cell-specific, BWP-specific and UE-group specific.

22. The method of claim 12, further comprising:
transmitting the CBs in a physical uplink shared channel (PUSCH) in a 5G NR network.
